(19) United States
(12) Patent Application Publication
(10) Pub. No.: US 2026/0029035 A1
(43) Pub. Date: Jan. 29, 2026

(54) SHIM SUPPORT FOR SUSPENSION ASSEMBLY

(71) Applicant: Fox Factory, Inc., Duluth, GA (US)

(72) Inventors: Andrew Taylor, Ben Lomond, CA (US); Ari Colton, San Diego, CA (US); Ivan Tong, Odenton, MD (US); Kurtis Wragg, San Diego, CA (US); Sam Buller, San Diego, CA (US)

(73) Assignee: Fox Factory, Inc., Duluth, GA (US)

(21) Appl. No.: 18/781,305

(22) Filed: Jul. 23, 2024

(51) Int. Cl. F16F 9/348; F16F 9/32

(52) U.S. Cl. CPC F16F 9/3485; F16F 9/3214; F16F 2222/12

(57) ABSTRACT

A piston with support surfaces is disclosed. The piston can include a shim sealing surface formed around an outer circumference of the piston configured to be in contact with a cover shim of a shim stack to prevent fluid from entering a cavity of a moat of the piston during a checked condition of a suspension assembly associated with the piston and configured to allow the fluid to pass between the cover shim and the shim sealing surface when pressure is applied to a moat side of said cover shim. The piston can further include a plurality of support surfaces configured to be in contact with the cover shim during the compression condition and not be in contact with the cover shim during a preload condition when a damper is not experiencing said checked condition.

### FIELD OF THE INVENTION

Embodiments of the present technology relate generally to support surfaces in a piston for a shim stack in a suspension assembly.

### BACKGROUND

Suspension or shock assemblies (e.g., dampers, shock absorbers, springs etc.) are used in numerous different vehicles and configurations to absorb some or all of a movement that is received at an unsprung portion of a vehicle before it is transmitted to a suspended portion of the vehicle. For example, when a wheel hits a pothole, the encounter will cause an impact force on the wheel. However, by utilizing suspension components including one or more shock assemblies, the impact force can be significantly reduced or even absorbed completely before it is transmitted to a person on a seat of the vehicle. A suspension assembly can include a piston and a shim stack.

### BRIEF DESCRIPTION OF THE DRAWINGS

Aspects of the present invention are illustrated by way of example, and not by way of limitation, in the accompanying drawings, wherein:

FIGS. 1A and 1B, are side views of a suspension assembly, shown in accordance with an embodiment.

FIG. 2A, is a perspective view of a dished piston, shown in accordance with an embodiment.

FIG. 2B is a cross section perspective view of portion of dished piston, shown in accordance with an embodiment.

FIG. 3A is a block diagram of a simulated stress test of a shim stack and dished piston, shown in accordance with an embodiment.

FIG. 3B is a graph of shim bending stress calculated results of the simulated testing, shown in accordance with an embodiment.

FIG. 3C is a block diagram of a simulated stress test of a shim stack and dished piston, shown in accordance with an embodiment.

FIG. 3D is a graph of shim bending stress calculated results of the simulated testing, shown in accordance with an embodiment.

FIG. 4 is a perspective view of a cover shim and a first shim, shown in accordance with an embodiment.

FIG. 5 is a perspective view of a piston with support surfaces, shown in accordance with an embodiment.

FIG. 6 is a perspective view of a portion of a piston, shown in accordance with an embodiment.

FIG. 7A is a block diagram of a simulated stress test of a shim stack and a piston including support surface, shown in accordance with an embodiment.

FIG. 7B is a block diagram of a simulated stress test of a shim stack and piston a including support surface, shown in accordance with an embodiment.

FIG. 7C is a graph of shim bending stress calculated results of the simulated testing, shown in accordance with an embodiment.

FIG. 7D is a block diagram of a simulated stress test of a shim stack and a piston including support surface, shown in accordance with an embodiment.

FIG. 7E is a graph of shim bending stress calculated results of the simulated testing, shown in accordance with an embodiment.

FIGS. 8A and 8B depict graphs displaying the results of testing, shown in accordance with an embodiment.

FIG. 9A, a perspective view of an alternative embodiment of a piston with support surfaces, shown in accordance with an embodiment.

FIG. 9B is a top view of a piston, shown in accordance with an embodiment.

FIG. 10 is a removable support surface, shown in accordance with an embodiment.

FIG. 11 is a piston with a plurality of support surfaces that have different elongated lengths, shown in accordance with an embodiment.

FIG. 12 is a partial cross section view a piston with two moats and two sets of support surfaces, shown in accordance with an embodiment.

The drawings referred to in this description should be understood as not being drawn to scale except if specifically noted.

### DESCRIPTION OF EMBODIMENTS

The detailed description set forth below in connection with the appended drawings is intended as a description of various embodiments of the present invention and is not intended to represent the only embodiments in which the present invention is to be practiced. Each embodiment described in this disclosure is provided merely as an example or illustration of the present invention, and should not necessarily be construed as preferred or advantageous over other embodiments. In some instances, well known methods, procedures, and objects have not been described in detail as not to unnecessarily obscure aspects of the present disclosure.

A piston of the present invention can be a digressive piston that can include a moat area also described as a dished area. In one embodiment, the present invention includes support surfaces in the dished area of the piston in order to increase contact area between a shim of a shim stack and the piston during high pressure checked or closed events. In one embodiment, the support surfaces allow shim deflection into the moat without the shim contacting the support surfaces to achieve a preloaded shim stack. Then during a high pressure checked event the shim can contact the support surfaces to distribute stresses caused by excessive shim deflection into the moat during the high pressure checked event.

### Suspension Assembly

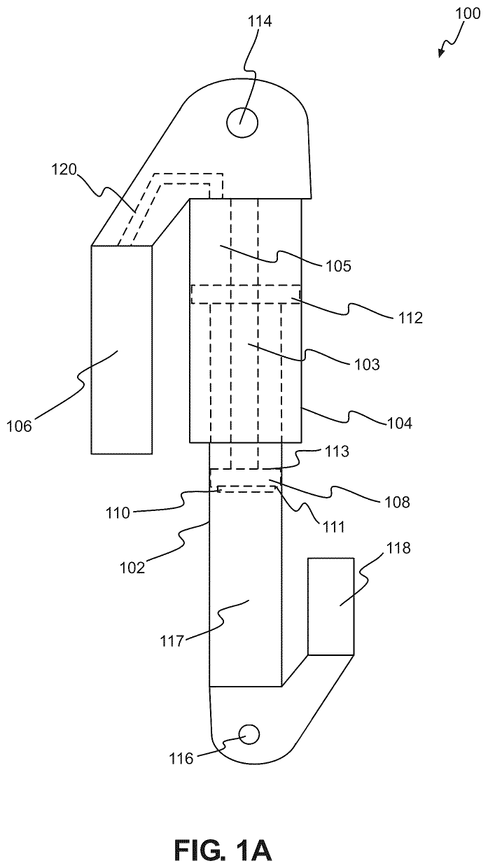

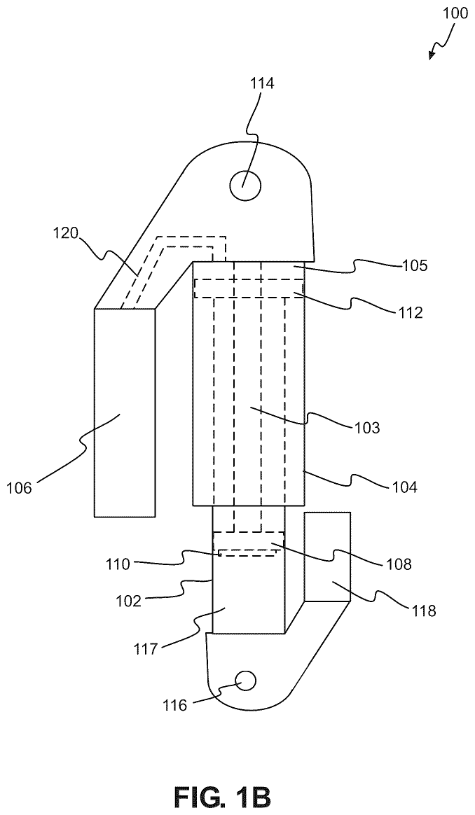

With reference now to FIGS. 1A and 1B, a side view of a suspension assembly 100 is provided. Suspension assembly 100 includes a lower body portion 102, a shaft 103, a main damper portion 104, a main gas chamber 105, a gas extra volume reservoir 106, a piston 108, a shim stack 110, first surface 111, a main gas chamber isolator 112, second surface 113, an eyelet mount 114, an eyelet mount 116, damper fluid 117, and a displaced fluid reservoir 118. In the present invention, during operation of suspension assembly 100, lower body portion 102 will move into or out of main damper portion 104. For example, when suspension assembly 100 is installed on a vehicle and the vehicle encounters a bump or other obstacle, lower body portion 102 travels into main damper portion 104.

Shaft 103 can be fixed or coupled to a component of suspension assembly 100 such as eyelet mount 114 or main damper portion 104. Piston 108 can be located at a distal end of shaft 103. In one embodiment, when lower body portion 102 travels into main damper portion 104, piston 108 remains stationary or fixed relative to main damper portion 104. Thus, the velocity of a compression event for suspension assembly 100 can be defined as the velocity at which lower body portion 102 moves relative to piston 108 during the compression event. Displaced fluid reservoir 118 may be in fluid communication with damper fluid 117 housed in lower body portion 102. While lower body portion 102 moves relative to piston 108 during a compression event, piston 108 forces or displaces damper fluid 117 into displaced fluid reservoir 118. Damper fluid 117 can be non-compressible and can be a fluid such as an oil. Displaced fluid reservoir 118 can include a fluid filled portion and a gas filled portion separated by a floating piston that movably seals the fluid filled portion from the gas filled portion of and can move during compression and rebound events. During a rebound event, lower body portion 102 can move relative to piston 108 and extend out of main damper portion 104 while piston 108 remains fixed.

Main gas chamber isolator 112 can be positioned at and coupled to an end of lower body portion 102 and be located within main damper portion 104. During a compression event main gas chamber isolator 112 moves with lower body portion 102 further into main damper portion 104 and creates less volume or space in main gas chamber 105. The less volume compresses the gas in main gas chamber 105. During a rebound event, main gas chamber isolator 112 moves with lower body portion 102 in a downward direction closer to piston 108 and the gas in main gas chamber 105 decompresses. FIG. 1A depicts suspension assembly 100 in a nearly fully extended state where lower body portion 102 is extended out main damper portion 104. The nearly fully extended state can occur immediately after a rebound event. FIG. 1B depicts suspension assembly 100 in a nearly fully compressed state where lower body portion 102 has entered main damper portion 104. The nearly fully compressed state can occur immediately after a compression event. Suspension assembly 100 can also include eyelet mount 114 and eyelet mount 116 which can be used to couple suspension assembly 100 to a vehicle such as a truck.

### Dished Piston

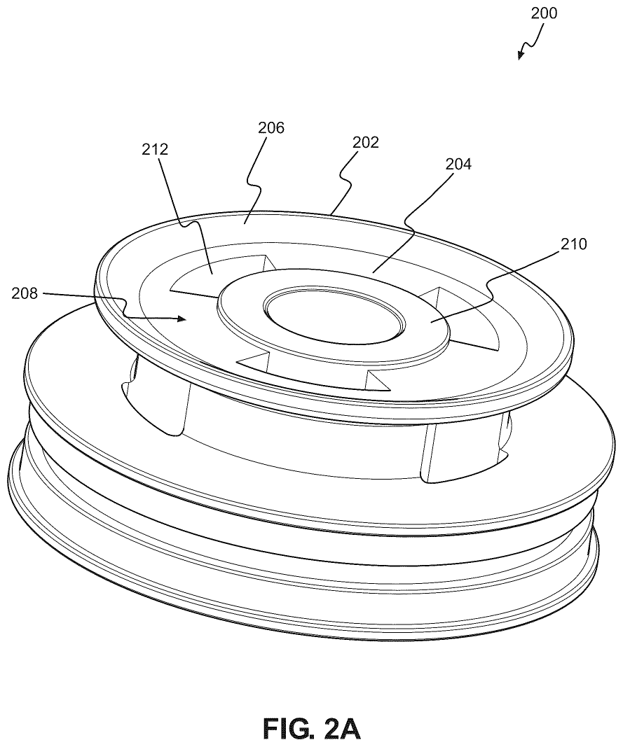

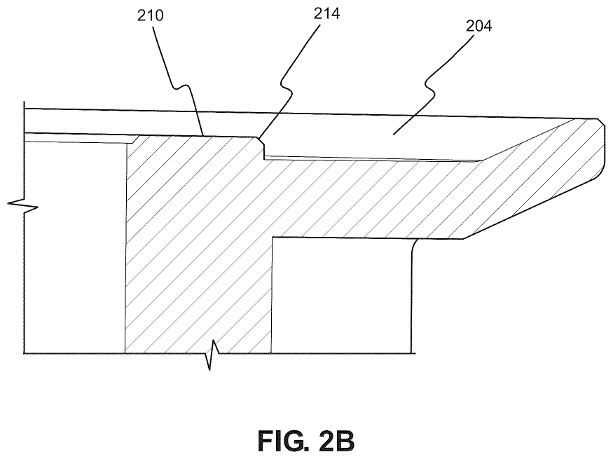

Referring now to FIG. 2A, a perspective view of a dished piston 200. Dished piston 200 can be piston 108 of FIGS. 1A and 1B and be part of suspension assembly 100. Dished piston 200 can include a shim sealing surface 202, a bottom surface 204, a dished surface 206, a moat 208, a hub surface 210, and a fluid port 212. In one embodiment, shim sealing surface 202 can be in contact with a shim stack. Shim sealing surface 202 can be described as shim sealing land. Shim sealing surface 202 can form a ring shape around an outer circumference of dished piston 200. Bottom surface 204 and dished surface 206 form moat 208 which is a cavity and can be described as a bowl like shape that holds fluid that is part of the suspension assembly. The moat 208 can also be described as a dished area. The angled shape of dished surface 206 is a defining characteristic of a dished piston. The dished piston 200 can also be described as a digressive piston. Moat 208 forming the cavity in the dished piston 200 can also be described as an undercut area or a relief area underneath a plane formed by shim sealing surface 202.

The fluid can pass through fluid port 212. In one embodiment, fluid port 212 is part of a plurality of fluid ports. The plurality of fluid ports can include any number of ports such as 2, 3, 4, or more ports. The plurality of fluid ports can be shaped in any number of shapes such as a curved trapezoid shape as depicted, a trapezoid shape, a rectangular shape, a kidney shape, an oval shape, etc. The plurality of fluid ports can be radially placed with even spacing around a circumference of hub surface 210.

FIG. 2B is a cross section perspective view of portion of dished piston 200 of FIG. 1A. FIG. 2B depicts bottom surface 204, hub surface 210, and a shoulder 214. It should be appreciated that FIGS. 2A and 2B do not depict support surfaces of the present invention used for a shim stack. In one embodiment, dished piston 200 can have the following dimensions: a moat depth of 0.060 inches, a de-load shoulder height of 0.030 inches, a pivot diameter of 0.750 inches, a shim sealing surface outer diameter of 0.800 inches and an inner diameter of 1.720 inches.

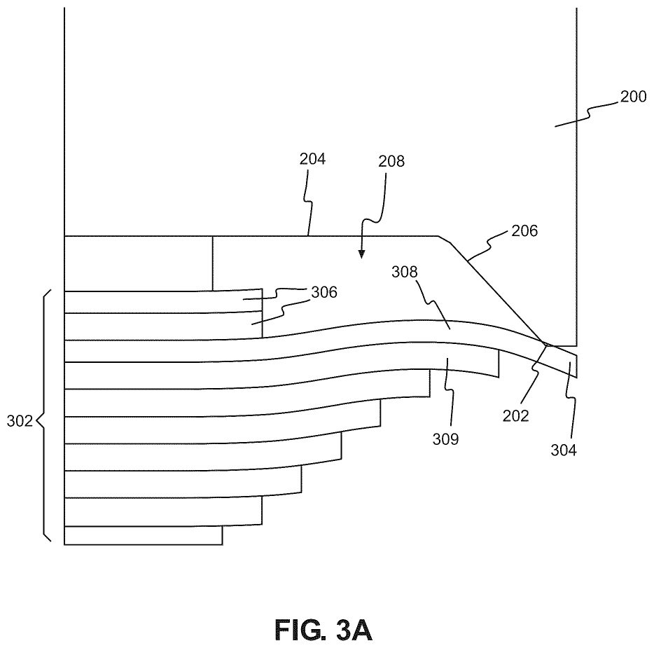

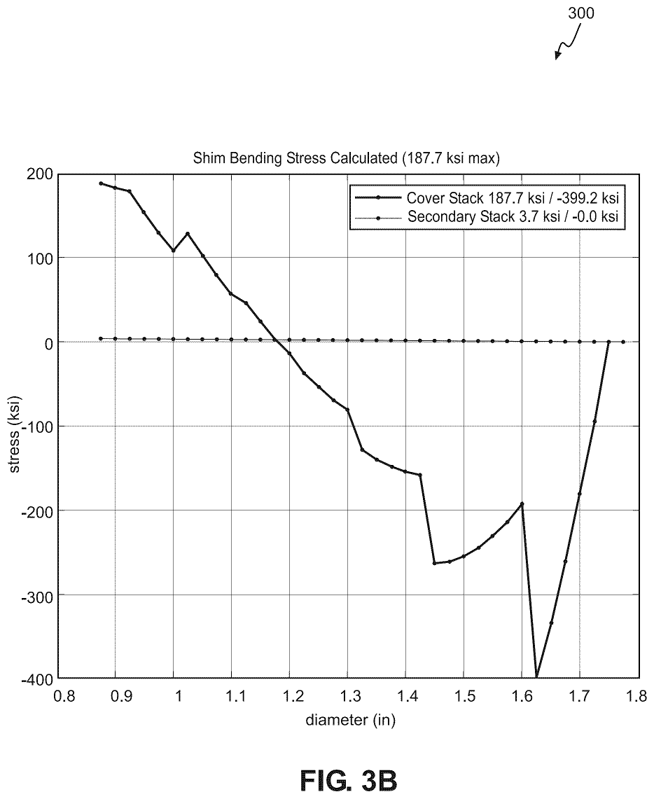

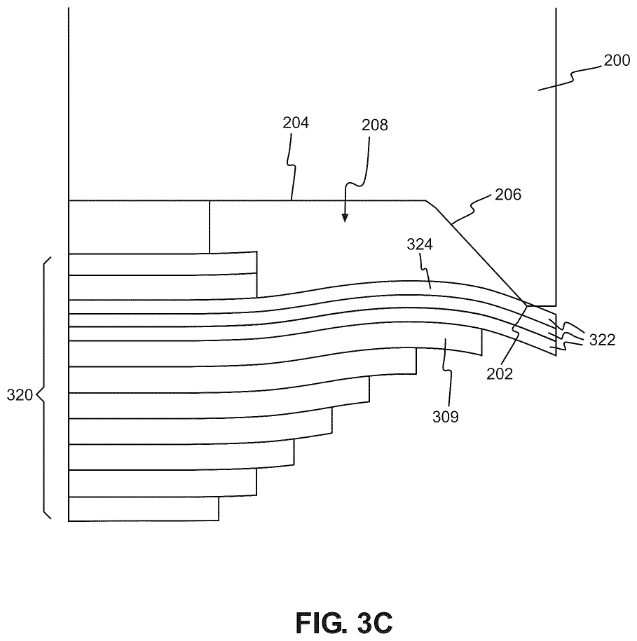

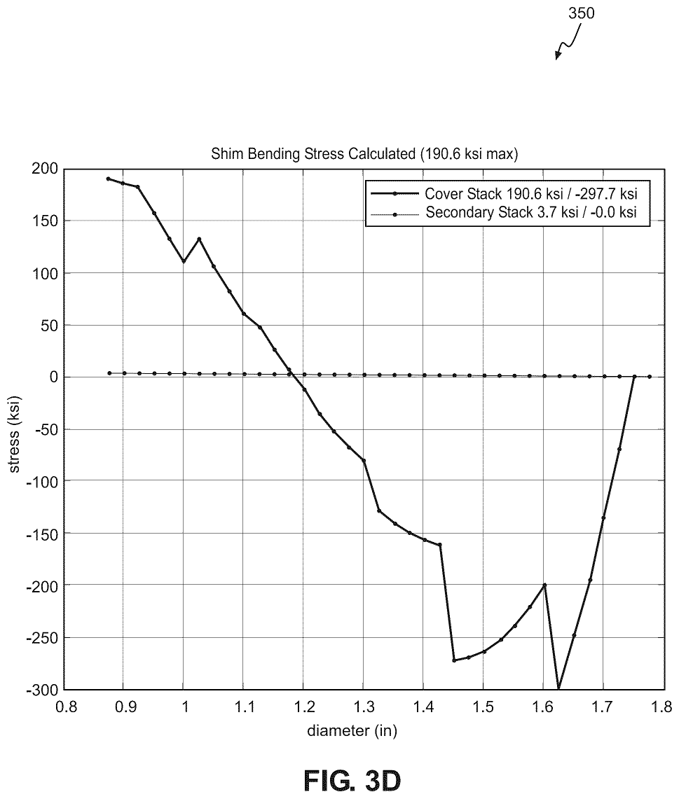

FIG. 3A depicts a block diagram of a simulated stress test of a shim stack 302 and dished piston 200. Shim stack 302 can include a plurality of shims. The shims can be made of various materials including carbon steel and are designed to flex during stress also described as shim deflection. Stress can be applied to shim stack 302 from different directions (bi-directional). For example, pre-load can cause stress in one direction while a compression event of the suspension assembly can cause stress in an opposite direction. In one embodiment, shim stack 302 can include a cover shim 304 and de-load shims 306. Shim stack 302 can include any number of shims of any number of diameters. FIG. 3A depicts shim stack 302 with a single cover shim 304. Cover shim 304 is depicted as the shim in shim stack 302 with the widest diameter and the shim that is wide enough to cover and contact shim sealing surface 202. FIG. 3A depicts shim stack 302 during a compression condition or checked condition such that cover shim 304 is in contact with shim sealing surface 202 and is deformed at point 308. In one embodiment, a shim such as cover shim 304 is designed to flex or deform to a certain limit under stress or load and then will return to a normal state after the stress has been removed. The stress can be applied via first shim 309 pressed against cover shim 304 where first shim 309 has a smaller diameter than cover shim 304. However, a shim can be deformed beyond the certain limit and be permanently deformed such that the shim will not return to a normal state. Such a permanent deformation can be referred to as coining. It should be appreciated that a shim stack with a given set of shims can be described as a tune for the suspension assembly and changing a shim in a shim stack can be considered changing to a different tune for the suspension assembly. Different tunes can affect or change a performance of the suspension assembly.

In one embodiment, in a suspension assembly, a shim stack with a cover shim in contact with a dished piston can be used as a check valve such that fluid in the moat of the dished piston can reach a certain pressure and crack a seal between the cover shim and the shim sealing surface of the dished piston thus allowing the fluid to escape from the moat. Conversely, a pressure or stress can cause the cover shim to seal tightly against the shim sealing surface of the dished piston and not allow the fluid to flow from outside of the piston into the moat area. Thus the shim stack and the dished piston can form a one-way valve or check valve for the fluid. A permanent deformation or coining of the cover shim can change the crack pressure needed to crack the cover seal from the shim sealing surface of the dished piston and thus change the performance of the suspension assembly. FIG. 3A depicts a dished piston without a support surface of the present invention and thus cover shim 304 is depicted as deforming at point 308 causing coining of cover shim 304 and deformations of the piston. Support surfaces of the present invention are designed to prevent coining of a cover shim. Coining of a cover shim can cause a reduction in shim stack preload, increase leakage and and thus cause a loss of force of the suspension assembly. Increasing a size or sealing diameter of a cover shim or rebound shim can also increase the likelihood of coining to occur. For example, moving from a cover shim with an outer diameter of 1.600 inches to an outer diameter of 1.800 inches may be desirable as part of the tuning of the suspension assembly but can increase the likelihood of coining due to the increased sealing area to shim contact area ratio.

FIG. 3B depicts a graph 300 of shim bending stress calculated results of the simulated testing depicted in FIG. 3A. Graph 300 depicts the stress vs. the diameter of the shim. Graph 300 depicts 1500 gauge pressure (psig) was simulated across dished piston 200. Cover shim 304 was simulated to have a thickness of 0.012 inches.

FIG. 3C depicts a block diagram of a simulated stress test of a shim stack 320 and dished piston 200. Shim stack 320 can include a plurality of shims. Shim stack 320 is depicted as including cover shims 322. Cover shims 322, as depicted, include three covers shims that cover shim sealing surface 202 and one of cover shims 322 contacts shim sealing surface 202. Each of cover shims 322 are depicted as deforming at point 324 causing deformation and coining.

FIG. 3D depicts a graph 350 of shim bending stress calculated results of the simulated testing depicted in FIG. 3C. Graph 350 depicts the stress vs. the diameter of the shim. Graph 350 depicts 1500 psig was simulated across dished piston 200. Cover shims 303 were each simulated to have a thickness of 0.008 inches. Comparing graph 300 of FIG. 3C to graph 350 confirms that three cover shims with a thickness of 0.008 inches as compared to a single cover shim with a thickness of 0.012 inches reduces the peak stress on the cover shims. Although the stress was reduced, the cover shim stress depicted in graph 350 is still above the proof strength of the shim material for both tunes and causes coining. Usage of shim stacks with a plurality of cover shims can improve shim durability but increase the shim stack stiffness required to ensure shim durability and prevent coining

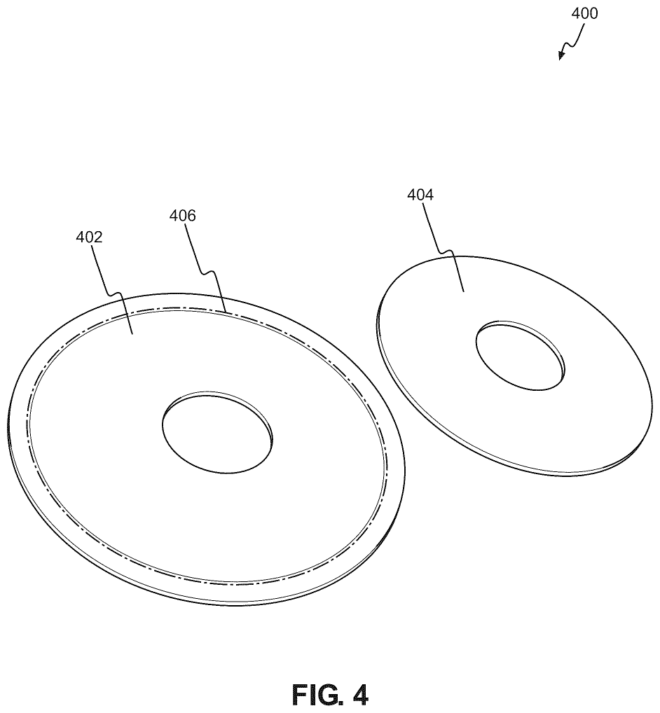

FIG. 4 depicts a perspective view 400 of cover shim 402 and first shim 404. In one embodiment, cover shim 402 and first shim 404 are cover shim 304 and first shim 309 of FIG. 3A. Cover shim 302 is depicted as coining after or during a compression event of a suspension assembly. For example, pressure drop across the main piston is hydraulically deforming cover shim 402 in an unsupported moat region. The force may be applied by first shim 404. Dotted ring 406 depicts where the deformation or coining has occurred on cover shim 402. A diameter of ring 406 is depicted as the same or similar as the outer diameter of first shim 404. Cover shim 402 is depicted as coining approximately 0.005 inches along a 1.59 diameter with main piston pressure drops of 1000 psig where first shim 404 has an outer diameter of 1.600 inches.

### Piston With Support Surfaces

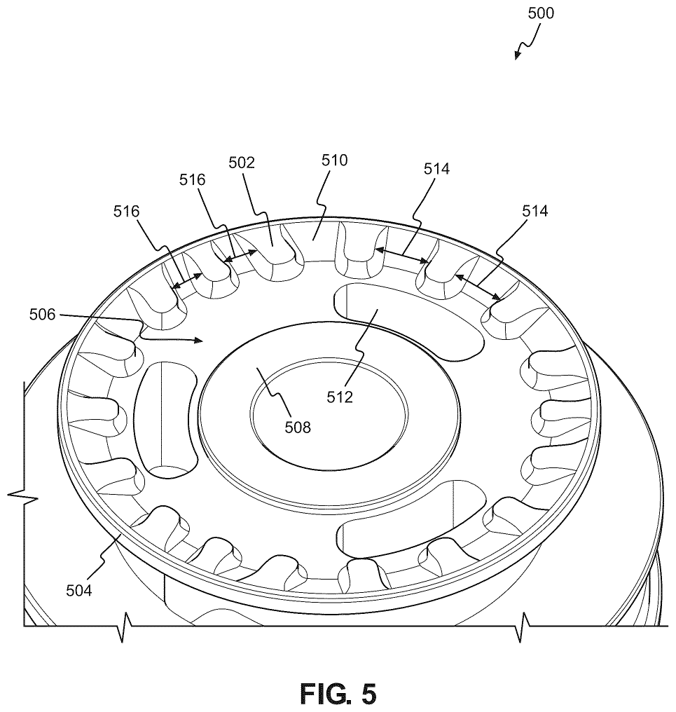

FIG. 5 depicts a perspective view of a piston 500 with support surfaces including support surface 502. Piston 500 can be a dished piston and can have features similar to dished piston 200 of FIG. 2A while also including support surfaces. Piston 500 is depicted as having a plurality of support surfaces each similar to support surface 502. The plurality of support surfaces are arraigned radially around a perimeter of piston 500. Each of the plurality of support surfaces can begin at shim sealing surface 504 and extend into moat 506 towards hub surface 508 or a center of piston 500. In one embodiment, the plurality of support surfaces can have a top surface that starts at shim sealing surface 504 or starts lower in moat 506 than shim sealing surface 504 and extends at an angle deeper into moat 506 as the top surface extends towards a center of piston 500. This can be described as a gradient or angled surface. In one embodiment, an angle of the top surface of support surface 502 is different than an angle formed by dished surface 510. Thus a cover shim that is in contact with shim sealing surface 504 that is under pressure from a checked condition or event can flex into moat 506 and will contact the top surfaces of the plurality of piston support surfaces before contacting dished surface 510 or a bottom surface of moat 506. The checked event can also be referred to as a compression condition or an extension condition. The cover shim contacting the plurality of support surfaces during a compression event or compression condition can distribute the pressure on the cover shim and thus prevent the cover shim from permanently deforming or coining. The top surface of the plurality of support surfaces being angled into moat 506 allows the cover shim to be in contact with the shim sealing surface 504 during a preload condition while not contacting the top surfaces of the plurality of support surfaces during the preload condition.

In one embodiment, fluid associated with the suspension assembly can enter moat 506 through port 512. Port 512 is depicted as one of three ports that are each kidney shaped. It should be appreciated that piston 500 can have any number of ports in any type of shape. Piston 500 in conjunction with a shim stack, including a cover shim that can cover and contact shim sealing surface 504 can form a check valve or one way valve that allows the fluid to flow out moat 506 passing between the cover shim and shim sealing surface 504 but does not allow the fluid to flow into the moat in between the cover shim and shim sealing surface 504. By forming a plurality of support surfaces, space is left between the plurality of support surfaces that allow the fluid to flow through the spaces and out of piston 500 between the cover shim and shim sealing surface 54. For example, space can be formed between each of the plurality of support surfaces. Space between the plurality of support surfaces can be evenly distributed or can be different spacing. In one embodiment, spaces between the plurality of support surfaces that are nearer to a fluid port can be greater as compared to spaces between plurality of support surfaces that are further from the fluid ports of the piston 500. For example, spaces 514 are closer to port 512 as compared to spaces 516. Spaces 514 are depicted as wider or greater in volume and space as compared to spaces 516. Spaces 514 with a greater volume that are nearer to port 512 as compared to spaces 516 ensure that the fluid can easily flow and be directed more easily into spaces 516 to ensure that the fluid flows out between the cover shim and shim sealing surface 504. A size of each of the plurality of support surfaces can be uniform or even relative to one another or can be different from one another. The plurality of support surfaces in piston 500 are depicted as terminating in a rounded or half-rounded shape. The plurality of support surfaces can be formed in any shape and can be terminated in any shape.

Piston 500 can be formed with the plurality of support surfaces integrated into piston 500. Alternatively, piston can be formed with none of the plurality of support surfaces and the plurality of support surfaces can be detachable or removable and can be added to or installed in piston 500.

In one embodiment, moat 506 with the plurality of support surfaces is formed in a first surface of piston 500 such as first surface 111 of piston 108 in FIG. 1A and thus can be used with a shim stack in a compressed condition of the suspension assembly. In one embodiment, moat 506 with the plurality of support surfaces is formed in a first surface of piston 500 such as second surface 113 of piston 108 in FIG. 1A and thus can be used with a shim stack in an extension condition of the suspension assembly. In one embodiment, piston 500 is formed with two moats and two sets of support surfaces and can be used with two shims stacks in both compression conditions and extension conditions of the suspension assembly.

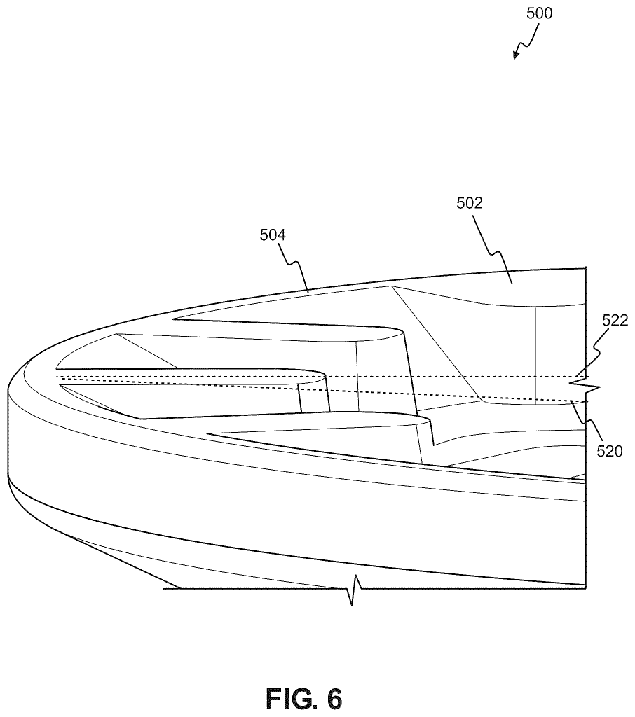

FIG. 6 is a perspective view of a portion piston 500. Lines 520 and 522 depict the angle or gradient that the plurality of support surfaces, including support surface 502, extend into the moat of piston 500. In one embodiment, piston 500 can have the following dimension: a moat depth of 0.060 inches, a de-load shoulder height of 0.030 inches, a pivot diameter of 0.875 inches, a cover shim outer diameter of 1.800 inches, a shim sealing inner diameter of 1.720 inches. Piston 500 is depicted in FIGS. 4 and 5 as having 18 support surfaces that are each 0.100 inches wide. It should be appreciated that the plurality of support surfaces can be any number of surface and have any dimensions or shapes. In one embodiment, the addition of the plurality of support surfaces can restrict fluid flow in the cavity or moat of the piston. A suspension assembly with a low pressure drop tune can experience more restrictions in fluid flow because the low pressure drop can require large flow areas as opposed to tunes with higher pressures.

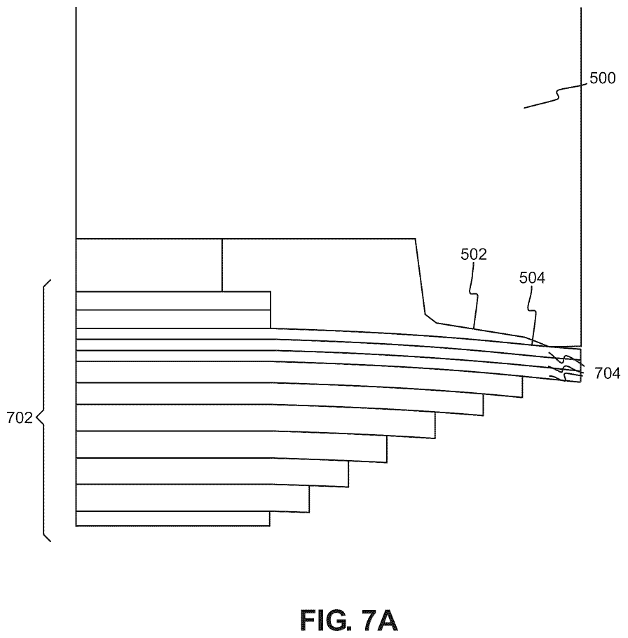

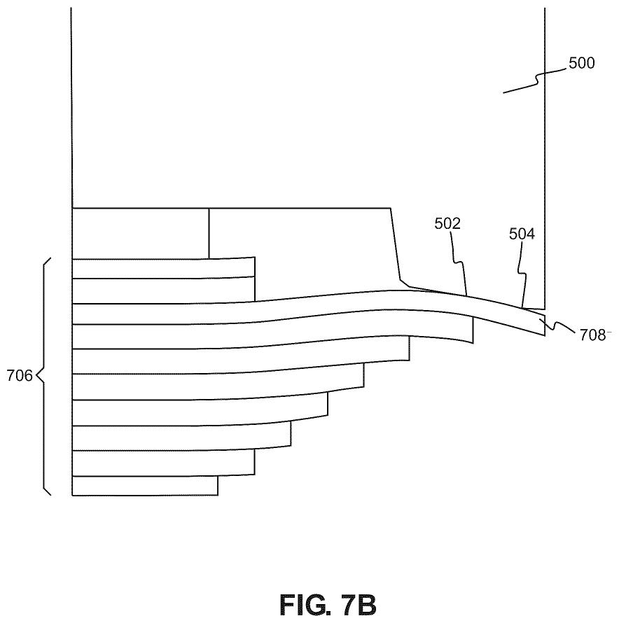

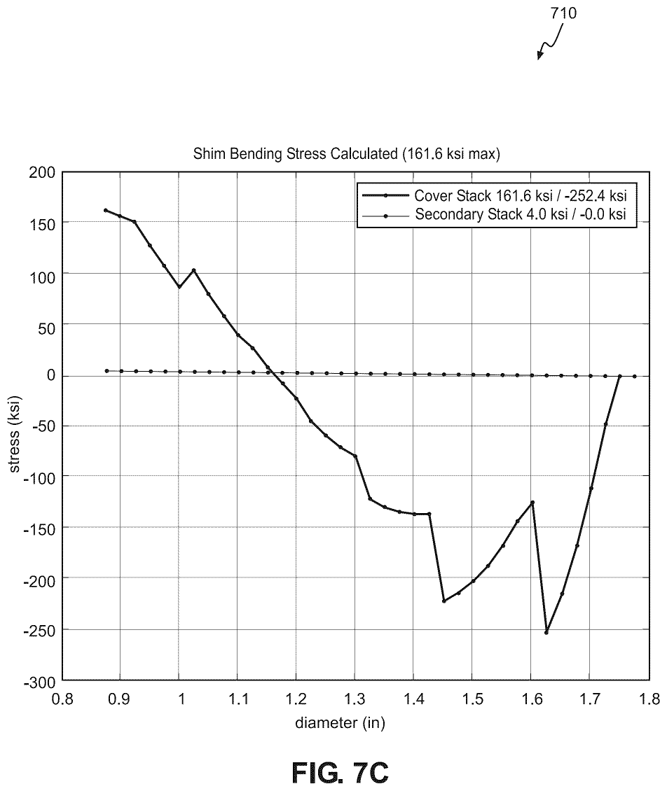

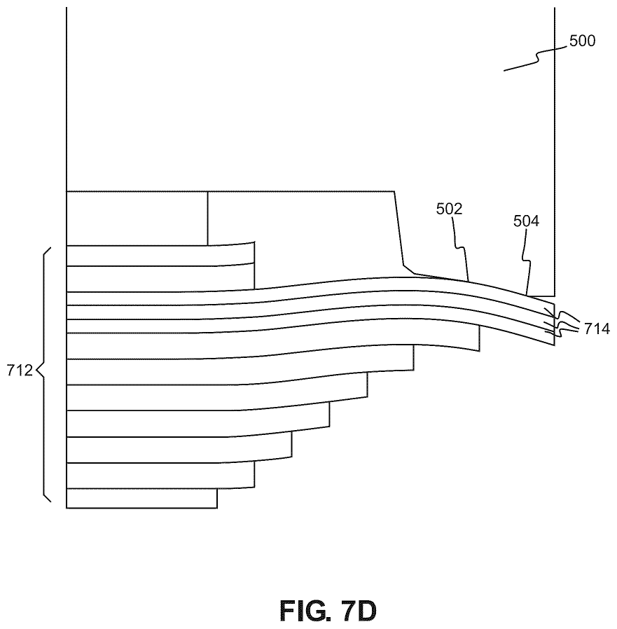

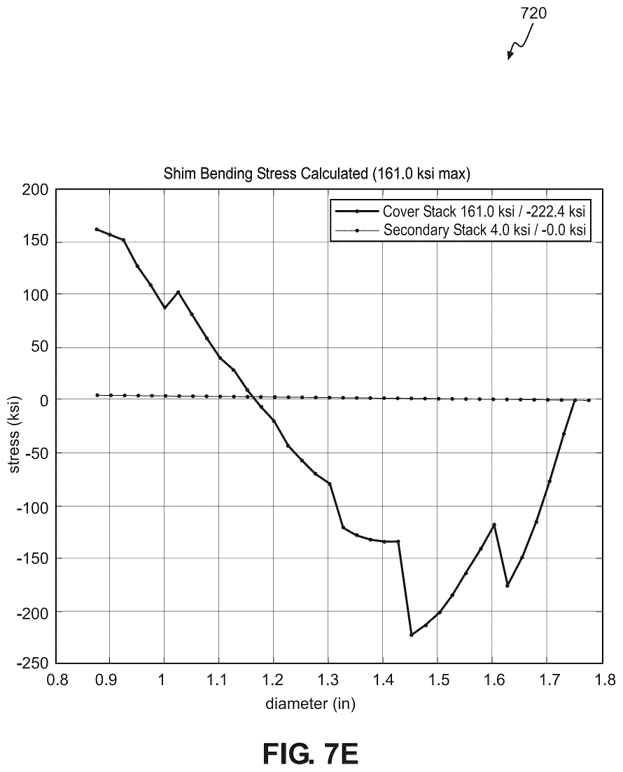

FIG. 7A depicts a block diagram of a simulated stress test of a shim stack 702 and piston 500 including support surface 502. Shim stack 702 can include a plurality of shims including cover shims 704 which depict a quantity of three cover shims. Shim stack 702 is depicted in a preload condition or during installation where a portion of one of the cover shims 704 is in contact with shim sealing surface 504 but the cover shim is not in contact with support surface 502. In one embodiment, such a configuration can be used with tunes that have stack preloads of up to 0.010 inches with no shim interference. In one embodiment, such a configuration can be used with tunes that have stack preloads of up to 0.012 inches with no shim interference.

FIG. 7B depicts a block diagram of a simulated stress test of a shim stack 706 and piston 500 including support surface 502. Shim stack 706 includes a plurality of shims including cover shim 708 which is depicted as a single cover shim. Shim stack 706 is depicted in a compression or checked condition where cover shim 708 has been partially deformed and a portion of cover shim 708 in contact with support surface 502. In one embodiment, cover shim 708 is in contact with support surface 502 distributes the stress placed upon cover shim 708 and the support surface 502 does not allow cover shim 708 to permanently deform or coin.

FIG. 7C depicts a graph 710 of shim bending stress calculated results of the simulated testing depicted in FIG. 7B. Graph 710 depicts the stress vs. the diameter of the shim. Graph 710 depicts 1500 gauge pressure (psig) was simulated across piston 500. Cover shim 304 was simulated to have a thickness of 0.012 inches.

FIG. 7D depicts a block diagram of a simulated stress test of a shim stack 712 and piston 500 including support surface 502. Shim stack 712 can include a plurality of shims including cover shims 714 which depict a quantity of three cover shims. Shim stack 712 is depicted in a compression or checked condition where cover shims 714 have been partially deformed and a portion of cover shims 714 is in contact with support surface 502. In one embodiment, cover shims 714 in contact with support surface 502 distributes the stress placed upon cover shims 714 and the support surface 502 does not allow cover shims 714 to permanently deform or coin.

FIG. 7E depicts a graph 720 of shim bending stress calculated results of the simulated testing depicted in FIG. 7D. Graph 720 depicts the stress vs. the diameter of the shim. Graph 720 depicts 1500 psig was simulated across piston 500. Cover shims 714 were each simulated to have a thickness of 0.008 inches. Comparing graph 720 of FIG. 7C to graph 710 confirms that three cover shims with a thickness of 0.008 inches as compared to a single cover shim with a thickness of 0.012 inches reduces the peak stress on the cover shims. Graphs 710 and 720 demonstrate that piston 500 with support surface 502 reduced stress in the cover shims to values at or below the material proof strength of the cover shim which was 247 ksi for these simulations.

Embodiments of the present technology have been tested with pistons that include support surfaces as described herein. For example, one test included 2 inch asymmetric sine wave, 5,000 cycles, and with a rebound speed—10 in/sec, a compression speed—75 in/sec (equivalent to 2,000 psid across piston). These test parameters were chosen to simulate the worst case pressure drop conditions that will occur on the main piston. This test was ran in a monotube shock and thereby eliminated all parallel bleed paths that occur in internal bypass live valve shocks. Rebound forces were monitored throughout the entirety of the 5,000 cycle test and the shock was dyno'd pre/post test to verify performance. The test resulted in a compression force loss of 200 lbF @ 20 in/sec, 6% which is acceptable. Shim fatigue (deformation) was expected given severity of test. The test resulted in no change to the rebound force. Detailed inspections of the shims post test were conducted.

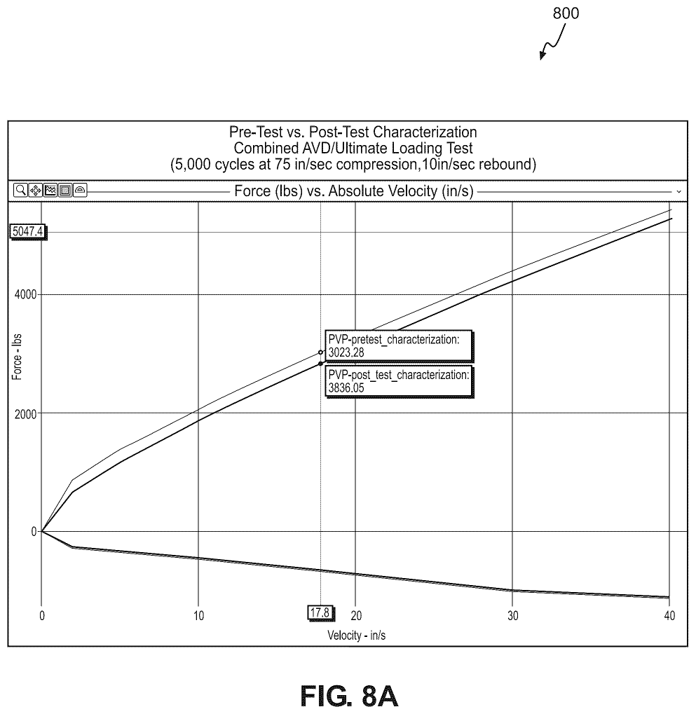

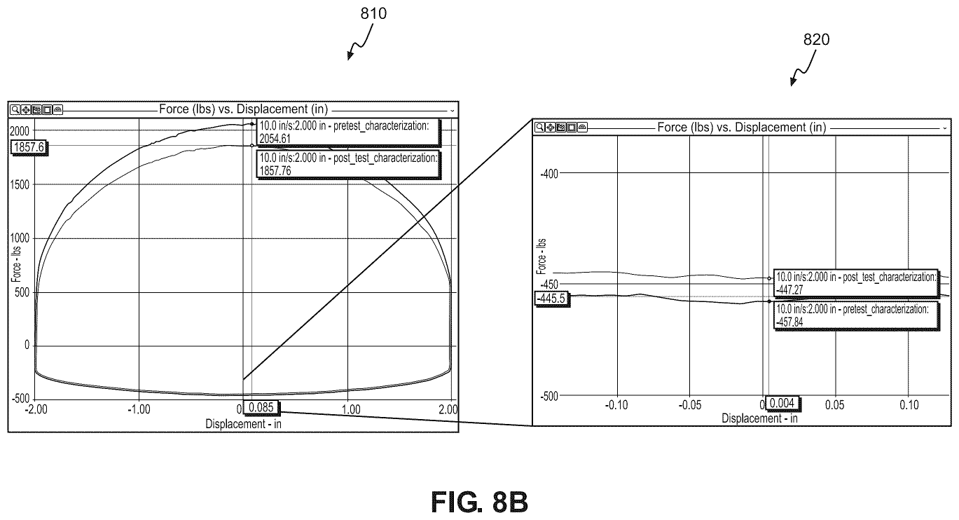

FIGS. 8A and 8B depict graphs 800, 810, and 820 displaying the results of the above described test. As a result of the test, the compression cover shim maintained a flatness of <0.001 which is within acceptable limits. The rebound cover shim maintained a flatness of <0.0025. Localized deformation noted at the de-load shim contact interface.

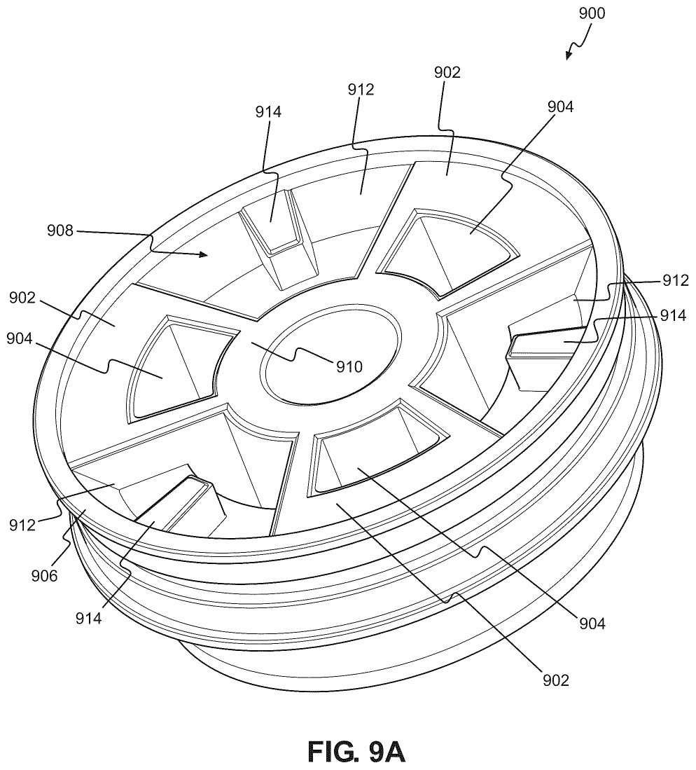

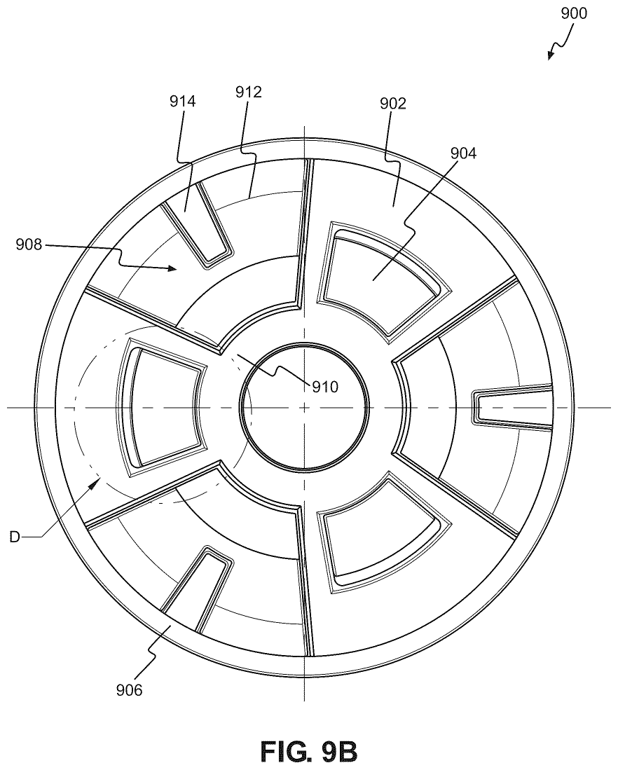

With reference now to FIG. 9A, a perspective view of an alternative embodiment of piston 900 with support surfaces. Piston 900 includes support surfaces 902 which include three surfaces each of which surround a port 904 for fluid. Each of support surfaces 902 start at or below shim sealing surface 906 and extend at an angle or gradient deeper into moat 908 and connect with hub surface 910. Hub surface 910 is flat or in a parallel plane to shim sealing surface 906 and is recessed deeper into moat 908. Cavities or spaces 912 are formed between each of support surfaces 902. Secondary support surfaces 914 are formed in each of spaces 912. The secondary support surfaces 914 start at or below shim sealing surface 906 and proceed at an angle or gradient toward hub surface 910 deeper into moat 908 but secondary support surfaces 914 do not contact hub surface 910 and do not fully span the distance of spaces 912.

FIG. 9B is a top view of piston 900.

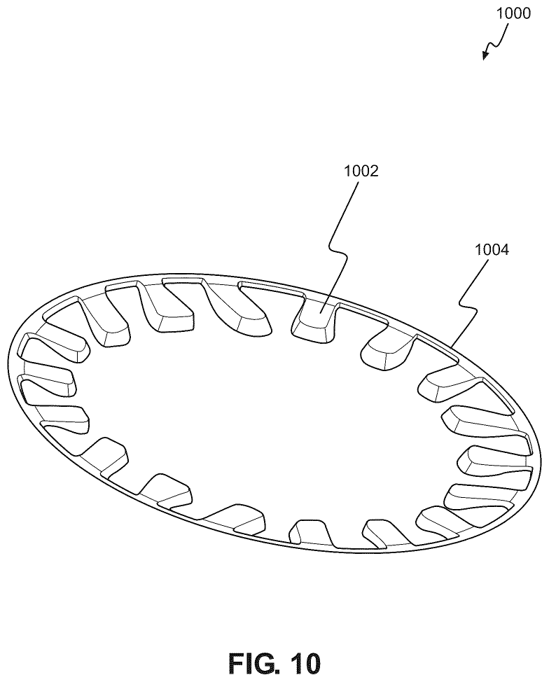

With reference to FIG. 10, a removable support surface 1000. Removable support surface 1000 can be employed with a dished piston that does not have support surfaces such as dished piston 200 of FIG. 2A. Dished piston can be a legacy piston and can be coupled with removable support surface 1000 for purposes of the present invention to provide support to a cover shim. Support surfaces 1002 can be connected via a ring such as ring 1004 or other connecting material. Removable support surface 1000 can be formed with any number of support surfaces 1002 in any type of shape. As an alternative to removable support surface 1000, a piston can be formed with integrated support surfaces. In one embodiment, removable support surface 1000 has been intentionally deformed to form support surfaces and can be placed between a cover shim and the piston where the intentionally deformed shim has an outer diameter smaller than the shim sealing surface and the cover shim.

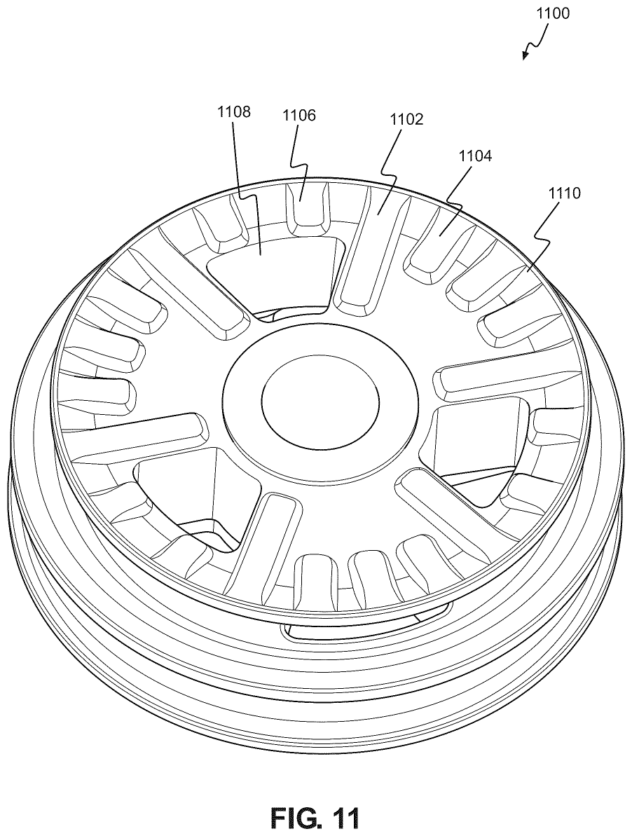

With reference to FIG. 11, a piston 1100 with a plurality of support surfaces that have different elongated lengths. Piston 1100 can have some features similar to piston 500 of FIG. 5 with some support surfaces of different lengths. For example, piston 1100 is depicted with support surfaces that have three different lengths including first support surface 1102, second support surface 1104, and third support surface 1106. The piston 1100 is depicted with six support surfaces that have the same length of first support surface 1102 each of the six support surfaces adjacent to a side of a fluid port such as port 1108. First support surface 1102 is the longest of the depicted support surfaces. Support surfaces with the same length as second support surface 1104 are located between the support surfaces with the longest length (first support surface 1102) in sections not adjacent to fluid ports. Third support surface 1106 and similar length support surfaces are located in sections between the support surfaces with the longest length (first support surface 1102) in sections containing a fluid port. These different length support surfaces assist in channeling fluid from the fluid ports to section of shim sealing surface 1110 closest to the fluid port the fluid came out of. First support surface 1102, second support surface 1104, and third support surface 1106 can each being at shim sealing surface 1110 and extend at an angle or gradient deeper into a moat of piston 1100 at an angle or gradient. Each of first support surface 1102, second support surface 1104, and third support surface 1106 can have a space in between to allow for fluid passages. Each of the plurality of support surfaces can be spaced radially around a circumference of piston 1100. Space between the plurality of support surfaces can be equal or different from one another. For example, space between support surfaces nearest a fluid port (third support surface 1106) can have more space between them relative to other support surfaces to assist in channeling the fluid. The design of piston 1100 can be described as a fluted design where a length of each of the elongated plurality of support surfaces is dependent upon a placement of each of the plurality of support surfaces relative to one of the plurality of fluid ports.

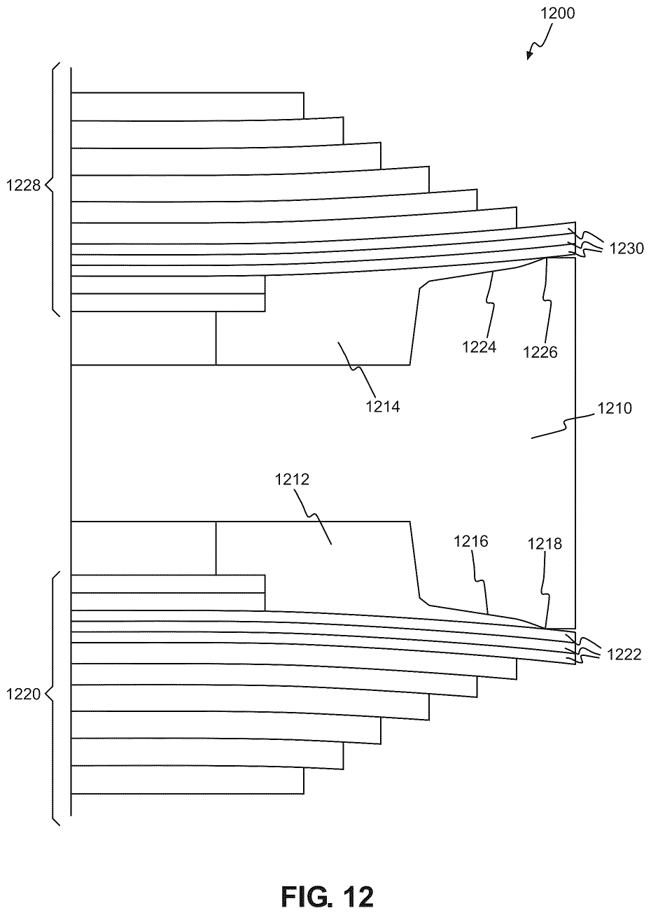

With reference to FIG. 12, a partial cross section view of a piston 1200 with two moats and two sets of support surfaces. Piston 1200 has a piston body 1210 with a first moat 1212 and a second moat 1214. First moat 1212 and second moat 1214 can be cavities in piston body 1210 that open in opposite direction of one another and are formed in opposing surfaces of piston body 1210. First moat 1212 and second moat 1214 can each for a dished portion in piston body 1210. A first set of support surfaces 1216 are formed in moat 1212 adjacent to shim sealing surface 1218. A shim stack 1220 includes cover shims 1222. Cover shims 1222 are in contact with a form a seal with shim sealing surface 1218. Cover shims 1222 flex during a compression event or compression condition and contact first set of support surfaces 1216.

Second set of support surfaces 1224 are formed in moat 1214 adjacent to shim sealing surface 1226. A shim stack 1228 includes cover shims 1230. Cover shims 1230 are in contact with a form a seal with shim sealing surface 1226. Cover shims 1230 flex during an extension event or extension condition and contact second set of support surfaces 1224. Cover shims 1222 and cover shims 1230 are each depicted as having three shims but can instead have one shim each or any other number of shims. Piston 1200 can be formed with only one moat on either side of piston 1200 or can be formed with both first moat 1214 with first set of support surfaces 1216 and with second moat with second set of support surfaces 1224. Piston 1200 can be used in a high pressure application in a suspension assembly where it is desirable to have first moat 1214 with first set of support surfaces 1216 and with second moat with second set of support surfaces 1224 with the support surfaces being employed in compression conditions and extension conditions.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments could be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What we claim is:

1. A piston with support surfaces, comprising:
a moat forming a cavity for fluid within said piston;
a plurality of fluid ports in said moat for allowing said fluid to pass into said piston;
a shim sealing surface formed around an outer circumference of said piston configured to be in contact with a cover shim of a shim stack to prevent said fluid from entering said cavity of said moat during a checked condition of a suspension assembly associated with said piston and configured to allow said fluid to pass between said cover shim and said shim sealing surface when pressure is applied to a moat side of said cover shim; and
a plurality of support surfaces configured to be in contact with said cover shim during said checked condition and not be in contact with said cover shim during a preload condition when a damper is not experiencing said checked condition.

2. The piston of claim 1, wherein said plurality of support surfaces form a gradient surface starting at said shim sealing surface and angling into said moat.

3. The piston of claim 1, further comprising a plurality of spaces between each of said plurality of support surfaces to allow said fluid to pass through.

4. The piston of claim 1, wherein said plurality of support surfaces are equally spaced radially around a circumference of said piston.

5. The piston of claim 1, wherein said plurality of support surfaces are unequally spaced radially around a circumference of said piston such that first spaces adjacent one of said plurality of fluid ports have greater volumes compared to second spaces not adjacent to said plurality of fluid ports.

6. The piston of claim 1, wherein said plurality of support surfaces have an elongated length extending toward a center of said piston and each of said plurality of support surfaces has an equal elongated length.

7. The piston of claim 1, wherein said plurality of support surfaces have an elongated length extending toward a center of said piston and a distance for said elongated length for each of said plurality of support surfaces is dependent upon a placement of each of said plurality of support surfaces relative to one of said plurality of fluid ports.

8. The piston of claim 1, wherein said plurality of support surfaces are integrated into said piston.

9. The piston of claim 1, wherein said plurality of support surfaces are detachable from said piston.

10. A suspension assembly, comprising:
a piston, comprising:
a moat forming a cavity for fluid within said piston;
a plurality of fluid ports in said moat for allowing said fluid to pass into said piston;
a shim sealing surface formed around an outer circumference of said piston;
a shim stack comprising a plurality of shims, comprising:
a cover shim that is flexible and configured to be in contact with said shim sealing surface of said piston to prevent said fluid from entering said moat of said piston during a checked condition of said suspension assembly and configured to allow said fluid to pass between said cover shim and said shim sealing surface when pressure is applied to a moat side of said cover shim; and
a plurality of support surfaces configured to be in contact with said cover shim during said checked condition and not be in contact with said cover shim during a preload condition when a damper is not experiencing said checked condition.

11. The suspension assembly of claim 10, wherein said plurality of support surfaces form a gradient surface starting at said shim sealing surface and angling into said moat.

12. The suspension assembly of claim 10, further comprising a plurality of spaces between each of said plurality of support surfaces to allow said fluid to pass through.

13. The suspension assembly of claim 10, wherein said plurality of support surfaces are equally spaced radially around a circumference of said piston.

14. The suspension assembly of claim 10, wherein said plurality of support surfaces are unequally spaced radially around a circumference of said piston such that first spaces adjacent one of said plurality of fluid ports have greater volumes compared to second spaces not adjacent to said plurality of fluid ports.

15. The suspension assembly of claim 10, wherein said plurality of support surfaces are integrated into said piston.

16. The suspension assembly of claim 10, wherein said plurality of support surfaces are detachable from said piston.

17. Support surfaces for a piston, comprising:
a plurality of support surfaces configured to be coupled with a piston associated with a suspension assembly and located within a moat of said piston, and further configured to be in contact with a cover shim associated said suspension assembly during a checked condition and not be in contact with said cover shim during a preload condition when a damper is not experiencing said checked condition.

18. The support surfaces of claim 17, further comprising a connective ring to connect said plurality of support surfaces to one another.

19. The support surfaces of claim 17, wherein said plurality of support surfaces form a gradient surface starting at said shim sealing surface and angling into said moat.

20. The support surfaces of claim 17, further comprising a plurality of spaces between each of said plurality of support surfaces to allow fluid to pass through.

21. A piston with two sets of support surfaces, comprising:
a first moat forming a first cavity for fluid within a first surface said piston;
a first shim sealing surface formed around an outer circumference of said first surface configured to be in contact with a first cover shim of a first shim stack to prevent a fluid from entering said first cavity of said moat during a compression condition of a suspension assembly associated with said piston and configured to allow said fluid to pass between said first cover shim and said first shim sealing surface;
a first set of support surfaces configured to be in contact with said first cover shim during said compression condition and not be in contact with said first cover shim during a preload condition;
a second moat forming a second cavity for said fluid within a second surface said piston wherein said first surface is an opposing surface of said second surface;
a second shim sealing surface formed around an outer circumference of said second surface configured to be in contact with a second cover shim of a second shim stack to prevent said fluid from entering said second cavity of said moat during an extension condition of a suspension assembly associated with said piston and configured to allow said fluid to pass between said second cover shim and said second shim sealing surface; and
a second set of support surfaces configured to be in contact with said second cover shim during said extension condition and not be in contact with said second cover shim during a preload condition.
